(19) United States
(12) Patent Application Publication
(10) Pub. No.: US 2025/0237277 A1
(43) Pub. Date: Jul. 24, 2025

(54) disc brake

(71) Applicant: HONDA MOTOR CO., LTD., Tokyo (JP)

(72) Inventor: Satoshi Takesako, Dublin, OH (US)

(73) Assignee: HONDA MOTOR CO., LTD., Tokyo (JP)

(21) Appl. No.: 18/417,692

(22) Filed: Jan. 19, 2024

(51) Int. Cl. F16D 65/00; F16D 55/00; F16D 55/225; F16D 65/097

(52) U.S. Cl. CPC F16D 65/0006; F16D 55/225; F16D 65/0068; F16D 65/0978; F16D 2055/0016

(57) ABSTRACT

A disc brake comprises a pair of friction pads disposed on both sides of a brake disc and supported by a caliper movably in a direction of the rotation axis, each of the friction pads comprising a back plate having a rotational direction end which is an end thereof in a rotational direction of the brake disc. The caliper comprises a support bracket extending in the direction of the rotation axis. The support bracket includes a first support surface configured to surface contact with a first contact surface of the rotational direction end of the back plate, the first support surface extending along a first plane inclined at a first angle θ1 relative to a normal plane perpendicular to a direction in which the braking torque acts on the pads such that a relative speed is generated between sliding direction of the brake disc and sliding direction of the pads.

### BACKGROUND

### Technical Field

The present disclosure relates to a disc brake.

### Related Art

A disc brake uses frictional force between a brake disc and a pair of friction pads disposed on both sides of the brake disc supported by a caliper movably in a direction of the rotation axis of the brake disc.

### SUMMARY

In one aspect of the present disclosure, a disc brake comprises:
a brake disc configured to rotate about a rotation axis thereof;
a caliper;
a pair of friction pads disposed on both sides of the brake disc and supported by the caliper movably in a direction of the rotation axis, each of the friction pads comprising a back plate having a rotational direction end which is an end thereof in a rotational direction of the brake disc,
wherein the caliper comprises a support bracket extending in the direction of the rotation axis, the support bracket supports the rotational direction end of the back plate by surface contact when the caliper presses the pair of friction pads against the brake disc to generate a braking torque applied on the pair of friction pads,
the support bracket includes a first support surface configured to surface contact with a first contact surface of the rotational direction end of the back plate, the first support surface extending along a first plane inclined at a first angle θ1 relative to a normal plane perpendicular to a direction in which the braking torque acts on the pads such that a relative speed is generated between sliding direction of the brake disc and sliding direction of the pads.

### BRIEF DESCRIPTION OF THE DRAWINGS

The advantages of the disclosure will become apparent in the following description taken in conjunction with the following drawings.

FIG. 1 is a front view of a disc brake according to one embodiment.

FIG. 2 is a partially cut out plan view of the disc brake according to one embodiment.

FIG. 3 is a front view of a disc brake according to one embodiment with a caliper removed.

FIG. 4 shows a first embodiment of the present application.

FIG. 5 shows a first embodiment of the present application.

FIG. 6 shows a comparative example of disc brake.

FIG. 7 schematically describes a model of the comparative example of FIG. 6.

FIG. 8 schematically describes a model of the first embodiment of the present application.

FIG. 9 schematically describes a model of the first embodiment of the present application.

FIG. 10 shows another embodiment of the present application.

FIG. 11 shows a second embodiment of the present application.

FIG. 12 shows a second embodiment of the present application.

FIG. 13 is a partial enlarged view of FIG. 11.

FIG. 14 describes a comparative example of disc brake.

FIG. 15 schematically describes a model of the second embodiment of the present application.

FIG. 16 shows another embodiment of the present application.

FIG. 17 shows another embodiment of the present application.

### DESCRIPTION OF EXEMPLARY EMBODIMENTS

Hereinafter, the present disclosure will be described through embodiments, but the following embodiments do not limit the invention according to the claims. In addition, not all combinations of features described in the embodiments are essential to the solution of the invention. Hereinafter, like elements are described by using like reference numerals and repetitive description of like elements employed in one or more embodiments described herein is omitted.

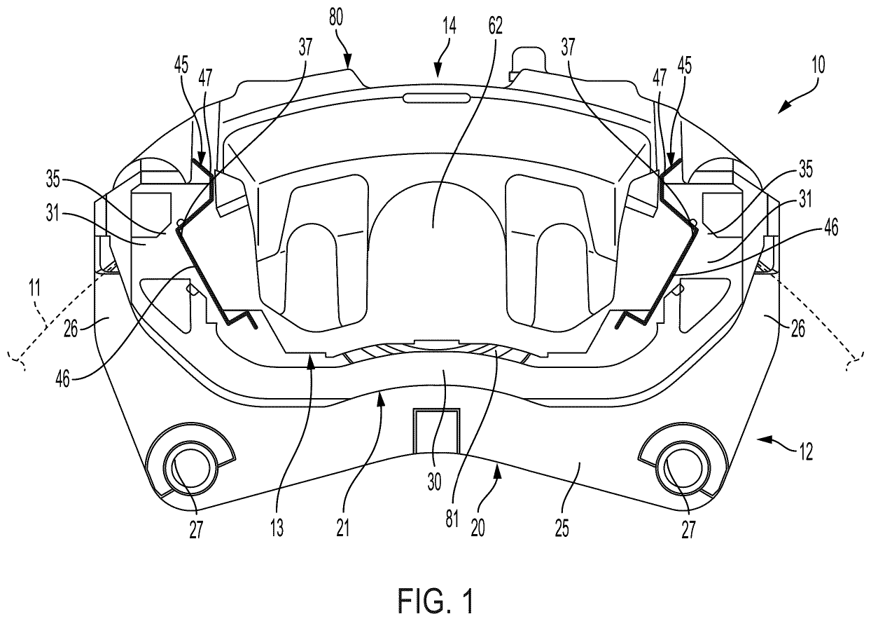

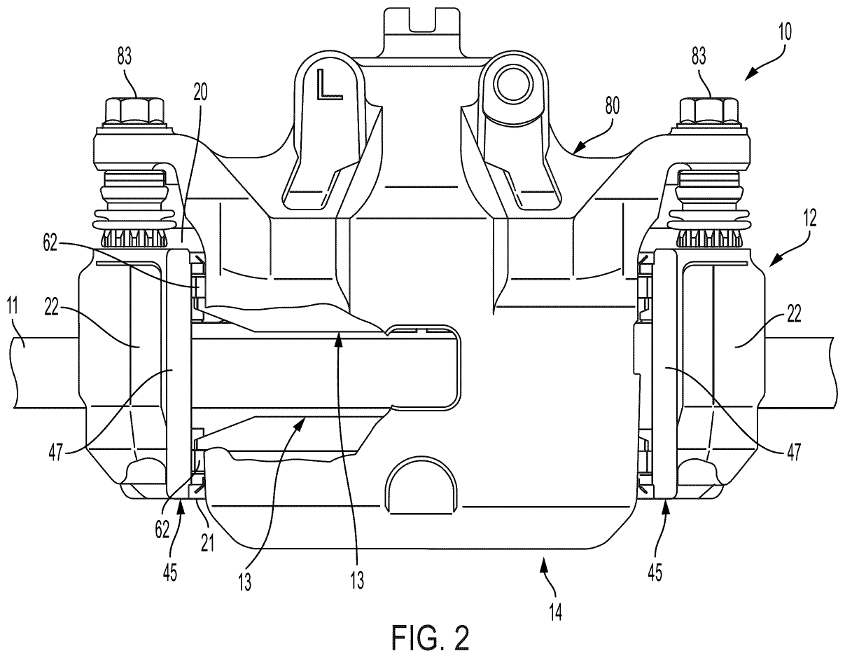

A disc brake according to an embodiment of the present application will be described below with reference to the drawings. FIG. 1 is a front view of a disc brake according to one embodiment. FIG. 2 is a partially cut out plan view of the disc brake according to one embodiment.

The disc brake 10 of the present embodiment shown in FIGS. 1 and 2 is for a vehicle, specifically for a four-wheeled vehicle, and brakes the vehicle by braking a disc 11 that rotates with a wheel (not shown). The embodiment is not limited to this. The disc brake can also be applied to other vehicles such as motorcycles. In the following, the radial direction of the disc 11, in particular, the line passing through the rotation center of the disc brake 10 and the rotation center of the disc 11 will be referred to as the disc radial direction, and the axial direction (rotation axis) of the disc 11 will be referred to as the disc axial direction. The rotational direction of the disc 11 is referred to as a disc rotation direction.

The disc brake 10 includes a carrier bracket 12, a pair of friction pads 13 and 13 shown in FIG. 2 which is supported so as to be slidable in the disc axial direction with the carrier bracket 12, and a caliper 14 which is supported so as to be slidable in the disc axial direction by the carrier bracket 12.

The carrier bracket 12 is disposed so as to straddle the radially outer side of the disc 11 and is fixed to a non-rotating portion of the vehicle. The pair of friction pads 13 and 13 are supported by the carrier bracket 12 on both sides thereof in the disc rotation direction in a state of being opposed to both surfaces of the disc 11, respectively. That is, the pair of friction pads 13 and 13 are slidably supported by the carrier bracket 12 on both sides of the disc 11, respectively.

The caliper 14 is supported by the carrier bracket 12 so as to be slidable in the disc axial direction while straddling the radially outer side of the disc 11, and to press the pair of friction pads 13, 13 against the disc 11 to generate frictional resistance and generate braking force.

The carrier bracket 12 includes a mounting base portion 20 disposed so as to face the inner side (vehicle width direction inner side) surface of the disc 11, an outer beam portion 21 disposed so as to face the outer side (vehicle width direction outer side) surface of the disc 11, and a pair of connecting portions 22, 22 that connect the mounting base portion 20 and the outer beam portion 21 at both ends thereof in the disc rotation direction at a location beyond the radially outer side of the disc 11.

As shown in FIG. 1, the inner mounting base portion 20 includes a base body portion 25 which extends along the disc rotation direction, and a pair of extending portions 26, 26 which extend outward in the disc radial direction from both ends of the base body portion 25 in the disc rotation direction. The ends of the pair of extending portions 26, 26 which are positioned opposite to the base body portion 25 are connected to the connecting portions 22, 22. As shown in FIG. 1, mounting holes 27, 27 are formed in the mounting base portion 20 at two locations on both ends of the base main body portion 25 in the disc rotation direction. The carrier bracket 12 is fixed to the non-rotating portion of the vehicle by a fastener inserted through the mounting holes 27, 27.

The outer beam portion 21 includes a beam main body portion 30 extending along the disc rotation direction, and a pair of extending portions 31, 31 extending outward in the disc radial direction from both ends of the beam main body portion 30 in the disc rotation direction. The ends of the pair of extending portions 31, 31 which are positioned opposite to the beam main body 30 are connected to the connecting portions 22, 22 as shown in FIG. 2.

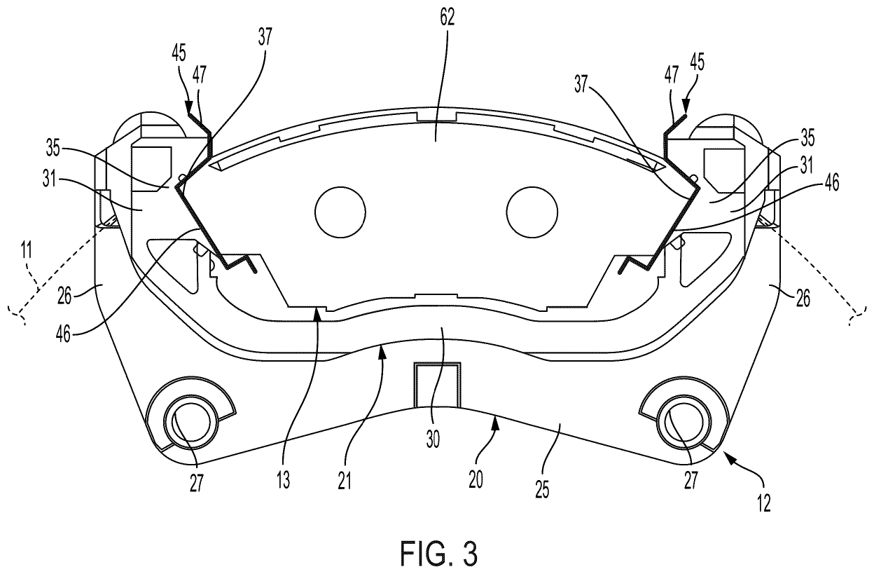

As shown in FIG. 3, the pair of extending portions 31, 31 of the outer beam portion 21 include respective side walls facing each other in the disc rotation direction. The pair of side walls are configured to be a pair of support portions 35, 35 that support an outer friction pad 13 at rotational direction ends thereof. The pair of extending portions 26, 26 of the mounting base portion 20 also include respective side walls facing each other in the disc rotation direction. The pair of side walls are configured to be a pair of support portions that support an inner friction pad 13 similarly (not shown). As shown in FIG. 3, the pair of support portions 35, 35 of the outer beam portion 21 have a mirror-symmetric shape. In addition, a pair of support portions 35, 35 (not shown) of the mounting base portion 20 have a mirror-symmetric shape.

As shown in FIG. 2, the caliper 14 includes a caliper body 80 that is supported by the carrier bracket 12 so as to be slidable in the disc axial direction while straddling the disc 11, a piston 81 shown in FIG. 1 that is slidably supported by the caliper body 80 so as to face one surface of the disc 11, and a claw portion 82 that is formed integrally with the caliper body 80 so as to face the other surface of the disc 11.

As shown in FIG. 2, the caliper body 80 has a pair of sliding pins 83 attached to both end portions in the disc rotation direction, and these sliding pins 83 are inserted into holes formed at the position of the connecting portion 22 of the carrier bracket 12. Thus, the caliper 14 is supported by the carrier bracket 12. The caliper 14 sandwiches the friction pads 13 and 13 between the piston 81 and the claw portion 82 that move forward by the brake fluid pressure, and press friction pads 13 and 13 toward the disc 11 to generate a braking torque applied on the pair of friction pads 13, 13.

Pad guides 45, 45 are shared by the pair of support portions 35, 35 of the outer beam portion 21 shown in FIG. 3 and the pair of support portions 35, 35 (not shown) of the mounting base portion 20 at portions thereof positioned on the same side in the disc rotation direction and aligned in the disc axial direction. The pad guides 45, 45 are two common parts between the pair of support portions 35, 35 of the outer beam portion 21 and the pair of support portions 35, 35 (not shown) of the mounting base portion 20. The pad guide 45 may be formed by pressing a plate member having a constant thickness.

One of the pair of pad guides 45 includes a bent guide plate portion 46 that covers the support concave surface 37 of the support portion 35 positioned on the one side in the disc rotation direction of the outer beam portion 21, a guide plate portion (not shown) that covers the support concave surface of the support portion 35 (not shown) of the mounting base portion 20 positioned on the same side as the support portion 35 in the disc rotation direction, and a connecting plate portion 47 that connects these guide plate portions. The other pad guide 45 also includes a bent guide plate portion 46 that covers the support concave surface 37 of the support portion 35 positioned on the other side in the disc rotation direction of the outer beam portion 21, a guide plate portion (not shown) that covers the support concave surface of the support portion 35 (not shown) of the mounting base portion 20 positioned on the same side as the support portion 35 in the disc rotation direction, and a connecting plate portion 47 that connects these guide plate portions.

Since the pair of support portions 35, 35 of the outer beam portion 21 and the pair of support portions (not shown) of the mounting base portion 20 all have the same shape, the support portion 35 at one place will be described hereinafter.

### First Embodiment

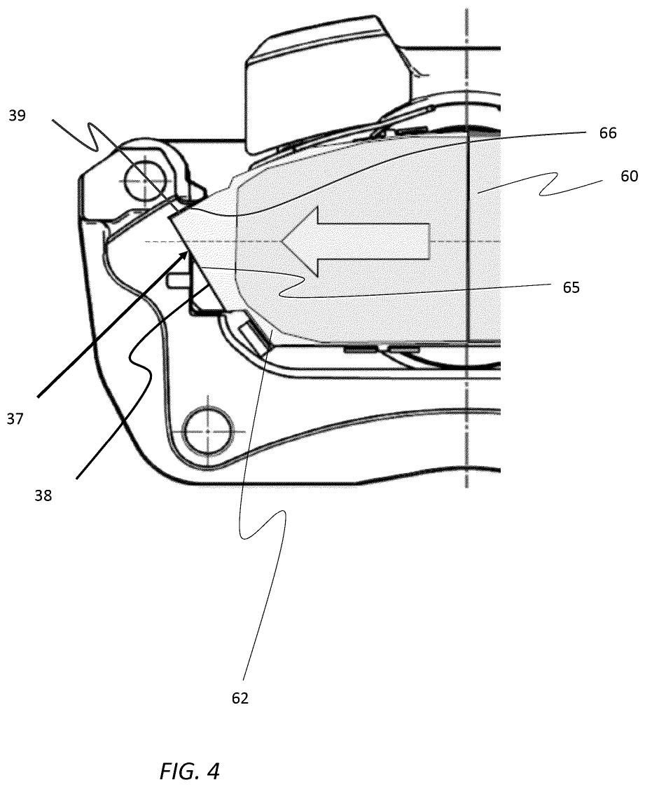

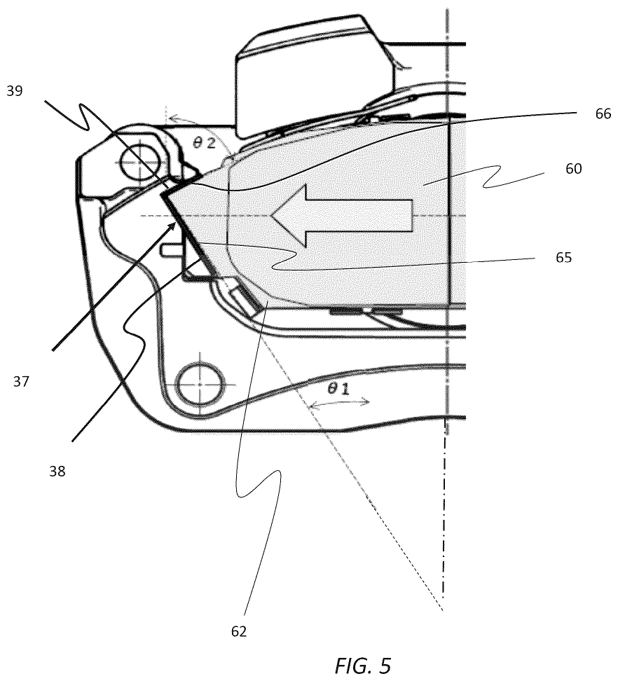

FIG. 4 and FIG. 5 each shows a first embodiment of the present application. FIG. 4 and FIG. 5 each shows a support portion 35 on the exit side of the outer beam portion 21 in the disc rotation direction. FIG. 4 and FIG. 5 each also shows the inner friction pad 13.

As shown in FIG. 4, the inner friction pad 13 includes a friction material 60 and a back plate 62 to which the friction material 60 is attached on one side in the thickness direction. The support portion 35 includes a concave support surface 37 that is recessed in the disc rotation direction. The concave support surface 37 faces a rotational direction end of the back plate 62 which is an end thereof in the rotational direction of the brake disc. The concave support surface 37 includes a first support surface 38 configured to face a first contact surface 65 of the rotational direction end of the back plate 62. The concave support surface 37 also includes a second support surface 39 configured to face a second contact surface 66 of the rotational direction end of the back plate 62.

The first support surface 38 is a substantially planar surface and extends along a first plane inclined at a first angle θ1 relative to a normal plane perpendicular to a direction in which the braking torque acts on the pads. The second support surface 39 is a substantially planar surface and extends along a second plane inclined at a second angle θ2 relative to the normal plane. Here, the first plane intersects with the second plane. The corner between the first support surface 38 and the second support surface 39 may be an angled corner or a curved corner.

The first contact surface 65 of the rotational direction end of the back plate 62 is configured to face the first support surface 38. The first contact surface 65 is a substantially planar surface and extends parallel to the first plane. The second contact surface 66 of the rotational direction end of the back plate 62 is configured to face the second support surface 39. The second contact surface 66 is a substantially planar surface and extends parallel to the second plane. The corner between the first contact surface 65 and the second contact surface 66 may be an angled corner or a curved corner.

When the caliper 14 presses the pair of friction pads 13, 13, the friction pads 13 and 13 on both sides slide in the axial direction of the disc to contact the disc 11, due to generated braking torque, the first support surface 38 comes into surface contact with the first contact surface 65 of the rotational direction end of the back plate 62, and the second support surface 39 comes into surface contact with the second contact surface 66 of the rotational direction end of the back plate 62.

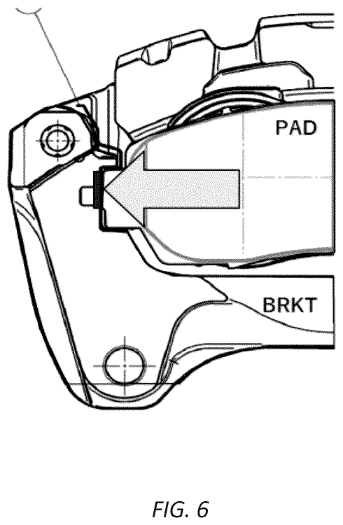

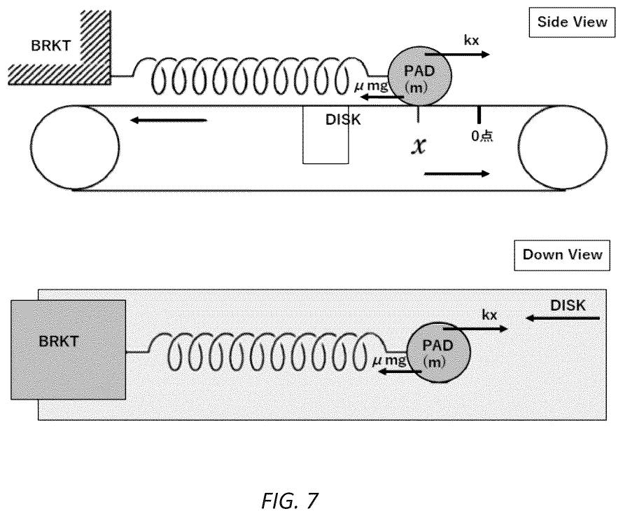

Now, a comparative example of a disc brake is described with reference to FIG. 6. FIG. 6 shows a comparative example of disc brake. AS shown by FIG. 6, the support surface which is configured to surface contact with the rotational end of the pad parallel is parallel to a normal plane perpendicular to a direction in which the braking torque acts on the pads. In the comparative example, behavior of a brake disc, a pad and a bracket may be described with reference to FIG. 7. FIG. 7 schematically describes a model of the comparative example of FIG. 6.

As described by FIG. 7, when sliding speed of the brake disc is lower, relative speed between the brake disc and the brake pad does not occur, and static friction is created. On the other hand, when sliding speed of the brake disc is higher, the relative speed between the brake disc and the brake pad occurs, dynamic friction is created. Due to switching between the static friction and the dynamic friction, and due to the difference between the static friction and the dynamic friction, vibration and brake noise are generated on the disc brake.

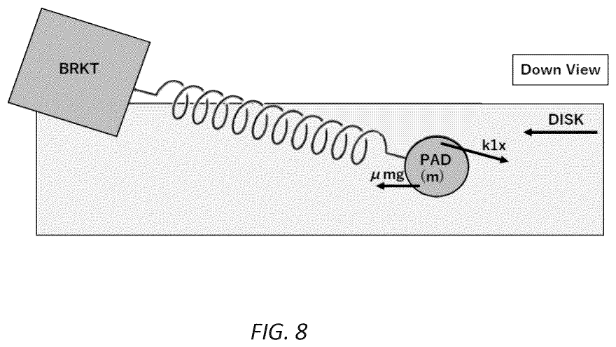

FIG. 8 schematically describes a model of the first embodiment of the present application in which the support surface is inclined relative to a normal plane perpendicular to a direction in which the braking torque acts on the pads. As described by FIG. 8, by applying an angle between the brake disc sliding direction and a spring force k1 by the bracket, there is always relative speed generated between the brake disc sliding direction and the pad sliding direction. Because there is always relative speed generated between the brake disc sliding direction and the pad sliding direction, vibration is prevented from being generated on the disc brake.

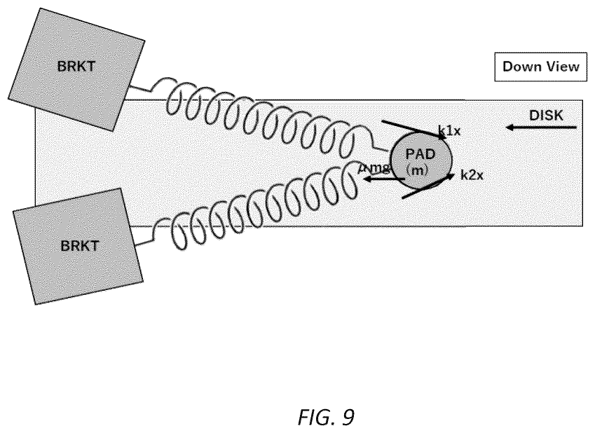

FIG. 9 schematically describes a model of the first embodiment of the present application in which another spring force is applied. As described by FIG. 9, by applying another sprig force k2 with different angle, the brake pad may be held and stabilized. In this model, when the relationship k2>>>k1 is satisfied, the spring force k1 is relatively dominant, and the model is operating similar to the model of FIG. 8.

### Support Surface

The first support surface 38 and the second support surface 39 are further described. As shown by FIG. 4, the first support surface 38 is inclined away from the center of the caliper in the rotational direction toward radially outer side. The first support surface 38 has a length along the first plane which is larger than a length of the second support surface along the second plane such that center of the braking torque is located in the first support surface 38. Also, the first contact surface 65 is a primary end surface of the rotational direction end of the back plate 60 and the second contact surface 66 is a secondary end surface of the rotational direction end of the back plate. By such a structure, posture of the friction pad 13 is more stabilized during braking operation.

It is preferable to have smaller value of the first angle θ1. Preferably, the first angle θ1 satisfies: 0°<θ1<45°. Further preferably, the first angle θ1 satisfies: 0°<θ1≤30°. By such a structure, the first support surface 38 may be a primary surface which receives the braking torque from the friction pad 13. Also, it is possible to have different amount of input torque to the support surface 38 different from that to the second support surface 39.

The second support surface 39 is provided radially outward of the first support surface with respect to a radial direction of the brake disc. It is preferable that the first plane intersects with the second plane at an angle greater than 90°. By such a structure, it is possible to hold, by the second support surface 39, the friction pad 13 abutting against the first support surface 38, while preventing undesirable effect by the second support surface 39 to the vibration caused by the first support surface 38.

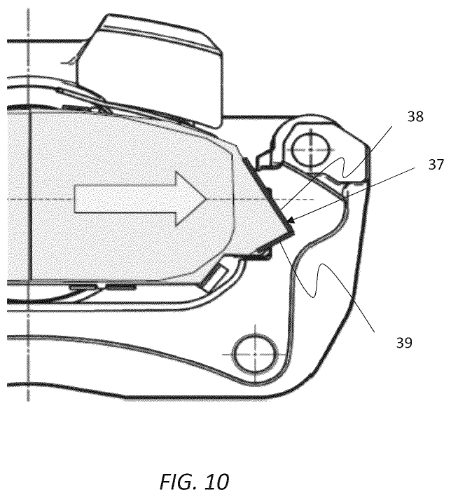

The embodiment is not limited to the above description. FIG. 10 shows another embodiment of the present application. As shown by FIG. 10, the first support surface 38 is inclined away from the center of the caliper in the rotational direction toward radially inner side. The second support surface 39 is provided radially inward of the first support surface with respect to a radial direction of the brake disc. It is preferable that the first plane intersects with the second plane at an angle greater than 90°. By such a structure, it is possible to hold, by the second support surface 39, the friction pad 13 abutting against the first support surface 38, while preventing undesirable effect by the second support surface 39 to the vibration caused by the first support surface 38.

### Second Embodiment

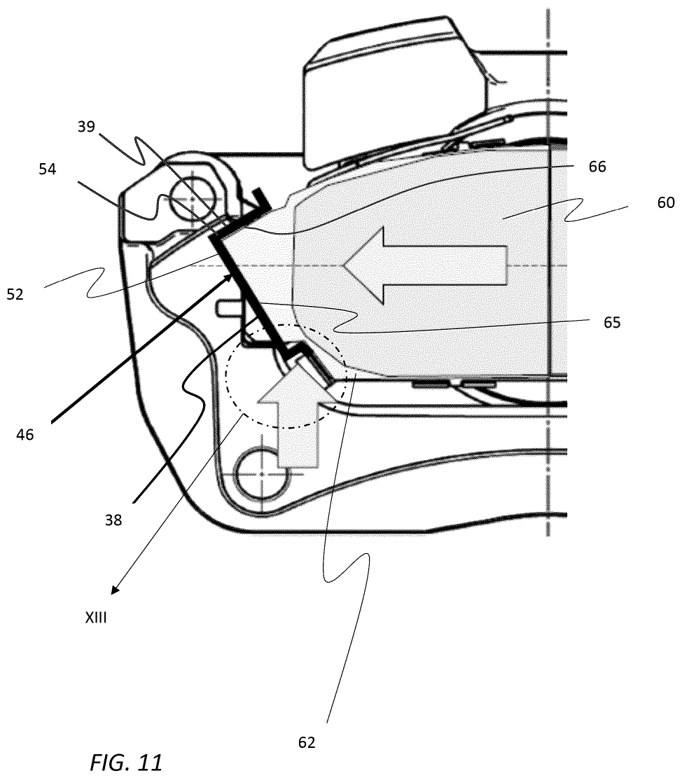

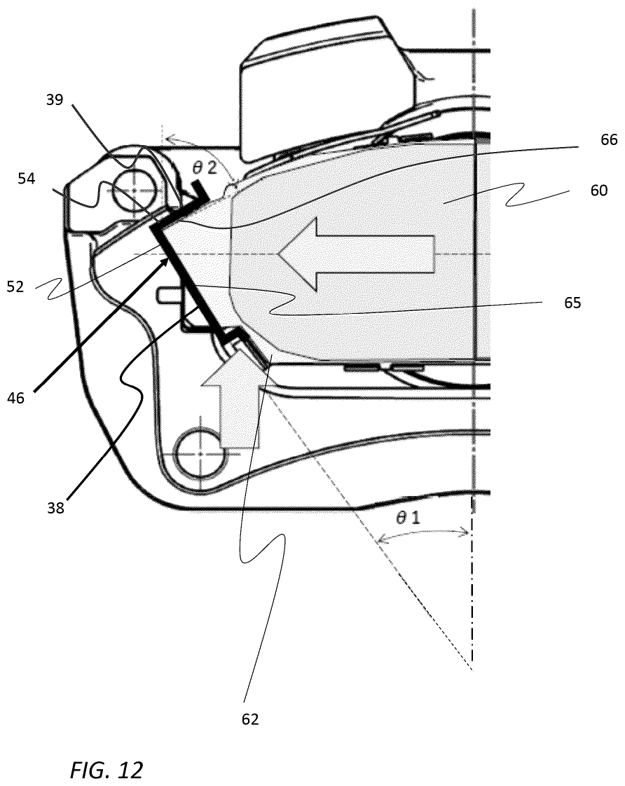

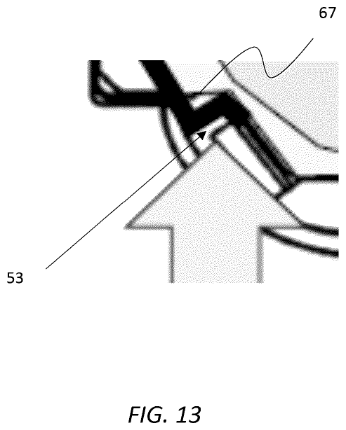

Now, a second embodiment of the present application is described. FIG. 11 and FIG. 12 each shows a second embodiment of the present application. FIG. 13 is a partial enlarged view of FIG. 11.

In the second embodiment, the support portion 35 includes the bent guide plate portion 46 along the support concave surface 37. The bent guide plate portion 46 of the pad guides 45 includes a first flat plate portion 52 and a second flat plate portion 54. The first flat plate portion 52 is parallel to the first support surface 38. The second flat plate portion 54 is parallel to the second support surface 39. The first flat plate portion 52 comes into surface contact with the first support surface 38 of the concave support surface 37. The second flat plate portion 54 comes into surface contact with the second support surface 39 of the concave support surface 37. Therefore, the guide plate portion 46 abuts against the concave support surface 37. The guide plate portion 46 is in contact with the concave support surface 37 and is provided along the disc axial direction. Further, as shown by FIG. 13, the guide plate portion 46 has a spring plate portion 53 which protrudes radially outwardly with respect to a radial direction of the brake disc. In the present embodiment, the spring plate portion 53 is disposed radially inward of the back plate 60 and applies an elastic bias to the back plate 62 radially outward such that the second contact surface 66 is pressed against the second support surface 39.

The back plate 62 includes a receiving surface 67 which is configured to face the spring plate portion 53 of the guide plate portion 46. The receiving surface 67 receives a bias force from the sprig plate portion 53 toward radially outwardly. The receiving surface 67 may be a flat surface parallel to the direction in which the braking torque acts on the pads.

When the caliper 14 presses the pair of friction pads 13, 13, the surface of the first flat plate portion 52 opposite to the first support surface 38 comes into surface contact with the first contact surface 65 of the rotational direction end of the back plate 62, and the surface of the second flat plate portion 54 opposite to the second support surface 39 comes into surface contact with the second contact surface 66 of the rotational direction end of the back plate 62. Also, the friction pads 13 and 13 on both sides slide in the axial direction of the disc with respect to the pad guides 45 and 45 and the carrier bracket 12 that support the friction pads 13 and 13 to contact the disc 11.

In the present embodiment, the first support surface of the support bracket in the claims corresponds to the surface of the first flat plate portion 52 which is configured to come into surface contact with the first contact surface 65, and the second support surface of the support bracket in the claims corresponds to the surface of the second flat plate portion 54 which is configure d to come into surface contact with the second contact surface 66.

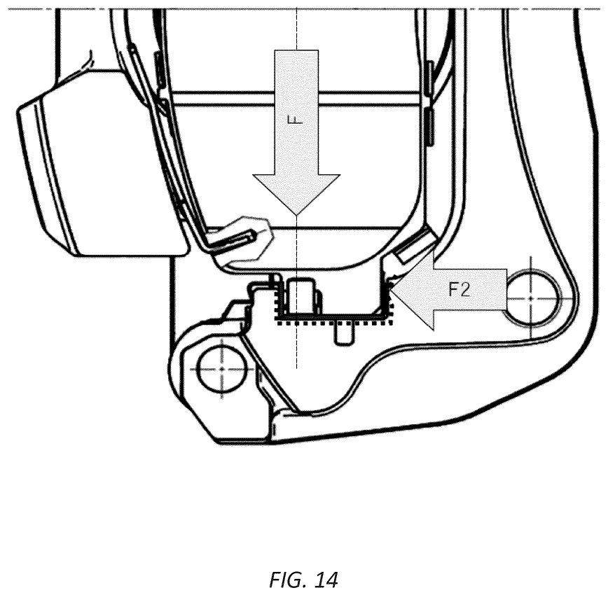

FIG. 14 describes a comparative example of disc brake. AS shown by FIG. 12, the support surface which is configured to surface contact with the rotational end of the pad parallel is parallel to a normal plane perpendicular to a direction in which the braking torque acts on the pads. When the vehicle goes over a bump or a dent on a road, a vibration force is generated in up-and-down direction which is applied to a friction pad. This applied vibration force may cause the friction pad to strike against a support surface and generate a striking noise.

This striking noise is controlled by “Pad mass (m)×Pad acceleration.” In the configuration of the comparative example of FIG. 14, the “Pad mass (m)×Pad acceleration” may be expressed:

$$“ Pad mass ( m ) \times Pad acceleration ” = \{ Vibration force input ( F ) + Pad mass ( M ) \} - A - B$$

Here, A={Spring force F2×μ×2}. This factor indicates friction resistance caused by the spring force at two contact surfaces.

Also, B={Spring force F2×μ×2}. This factor indicates friction resistance at two portions between the spring and the pad surfaces.

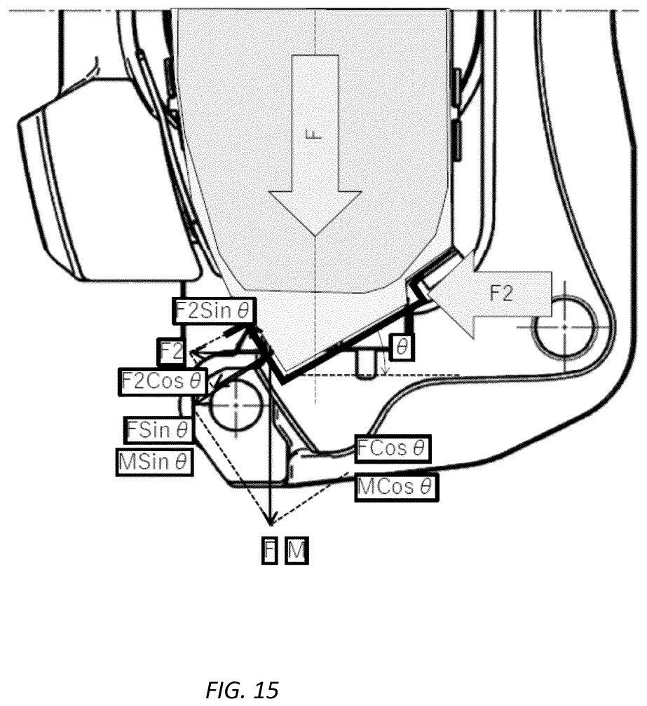

FIG. 15 schematically describes a model of the second embodiment of the present application. In the configuration of the model of FIG. 15, the “Pad mass (m)×Pad acceleration” may be expressed:

$$“ Pad mass ( m ) \times Pad acceleration ” = \{ Vibration force input ( F ) \times Cos θ + Pad mass ( M ) \times Cos θ \} - D - E - G - H$$

Here, D={(F+Pad mass (M))×μ×Sin θ}. This factor indicates friction resistance on the first contact surface.
E={F2×Sin θ}. This factor indicates force against sliding on the second contact surface caused by the spring force.
G={F2×Cos θ×μ}. This factor indicates friction resistance on the second contact surface.
H={F2×μ×2}. This factor indicates friction resistance at two portions between the spring and the pad surfaces.

As described above, since the first support surface 38 has an inclination angle θ1, the pad sliding direction is angled relative to the vibration force (F) input direction. This structure may increase friction force which works against the vibration force (F) input. Thus, striking noise may be reduced.

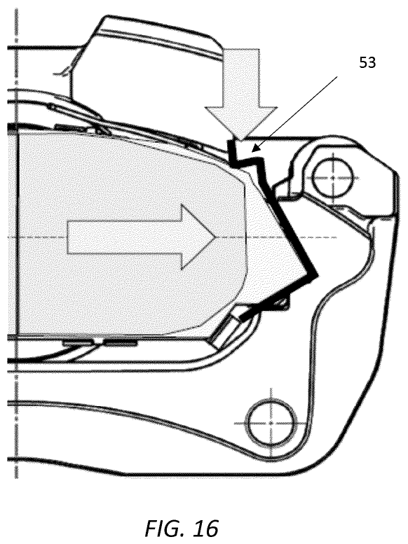

The embodiment is not limited to the above description. FIG. 16 shows another embodiment of the present application. As shown by FIG. 16, the first support surface 38 is inclined away from the center of the caliper in the rotational direction toward radially inner side. The second support surface 39 is provided radially inward of the first support surface with respect to a radial direction of the brake disc.

In the present embodiment, the spring plate portion 53 is disposed radially outward of the back plate 60 and applies an elastic bias to the back plate 62 radially inward such that the second contact surface 66 is pressed against the second support surface 39.

### Example 1

According to inventor's simulation, the pad acceleration can be reduced by 50% with the condition that the first angle θ1 is 30° and the second angle θ2 is 45° by using the same spring force compared to the structure of the comparative example of FIG. 14.

### Third Embodiment

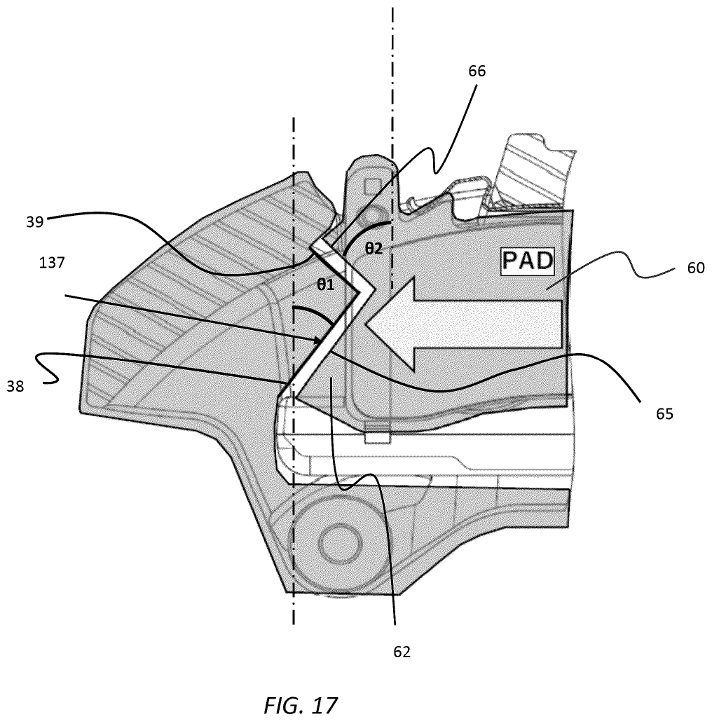

In the above-described embodiments, the support portion 35 includes a concave support surface 37 that is recessed in the disc rotation direction. However, the present application is not limited to this configuration. The support portion 35 may include a support surface that is protruded opposite to the disc rotation direction. For example, FIG. 17 shows another embodiment of the present application. As shown in FIG. 17, the support portion 35 includes a convex support surface 137 that is protruded opposite to the disc rotation direction. The convex support surface 137 faces a rotational direction end of the back plate 62 which is an end thereof in the rotational direction of the brake disc. The rotational direction end of the back plate 62 has a concave shape conforming to the convex support surface 137.

The convex support surface 137 includes a first support surface 38 configured to face a first contact surface 65 of the rotational direction end of the back plate 62. The convex support surface 137 also includes a second support surface 39 configured to face a second contact surface 66 of the rotational direction end of the back plate 62.

The first support surface 38 is a substantially planar surface and extends along a first plane inclined at a first angle θ1 relative to a normal plane perpendicular to a direction in which the braking torque acts on the pads. The second support surface 39 is a substantially planar surface and extends along a second plane inclined at a second angle θ2 relative to the normal plane. Here, the first plane intersects with the second plane. The corner between the first support surface 38 and the second support surface 39 may be an angled corner or a curved corner.

The first contact surface 65 of the rotational direction end of the back plate 62 is configured to face the first support surface 38. The first contact surface 65 is a substantially planar surface and extends parallel to the first plane. The second contact surface 66 of the rotational direction end of the back plate 62 is configured to face the second support surface 39. The second contact surface 66 is a substantially planar surface and extends parallel to the second plane. The corner between the first contact surface 65 and the second contact surface 66 may be an angled corner or a curved corner.

When the caliper 14 presses the pair of friction pads 13, 13, the friction pads 13 and 13 on both sides slide in the axial direction of the disc to contact the disc 11, due to generated braking torque, the first support surface 38 comes into surface contact with the first contact surface 65 of the rotational direction end of the back plate 62, and the second support surface 39 comes into surface contact with the second contact surface 66 of the rotational direction end of the back plate 62.

The first support surface 38 is inclined to the center of the caliper in the rotational direction toward radially outer side. The first support surface 38 has a length along the first plane which is larger than a length of the second support surface along the second plane such that center of the braking torque is located in the first support surface 38. Also, the first contact surface 65 is a primary end surface of the rotational direction end of the back plate 60 and the second contact surface 66 is a secondary end surface of the rotational direction end of the back plate. By such a structure, posture of the friction pad 13 is more stabilized during braking operation.

Moreover, the above-described configuration of the third embodiment may also be applied to other embodiments described above, for example, by FIGS. 4, 5, 10, 11, 12. Those modifications are also covered by the accompanying claims.

Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

What is claimed is:

1. A disc brake comprising:
a brake disc configured to rotate about a rotation axis thereof;
a caliper;
a pair of friction pads disposed on both sides of the brake disc and supported by the caliper movably in a direction of the rotation axis, each of the friction pads comprising a back plate having a rotational direction end which is an end thereof in a rotational direction of the brake disc,
wherein the caliper comprises a support bracket extending in the direction of the rotation axis, the support bracket supports the rotational direction end of the back plate by surface contact when the caliper presses the pair of friction pads against the brake disc to generate a braking torque applied on the pair of friction pads,
the support bracket includes a first support surface configured to surface contact with a first contact surface of the rotational direction end of the back plate, the first support surface extending along a first plane inclined at a first angle θ1 relative to a normal plane perpendicular to a direction in which the braking torque acts on the pads such that a relative speed is generated between sliding direction of the brake disc and sliding direction of the pads.

2. The disc brake according to claim 1, wherein the support bracket includes a second support surface configured to surface contact with a second contact surface of the rotational direction end of the back plate,
the second support surface extends along a second plane inclined at a second angle θ2 relative to the normal plane,
the first plane intersects with the second plane.

3. The disc brake according to claim 1, further comprising:
a spring applying an elastic bias to the back plate such that the second contact surface is pressed against the second support surface.

4. The disc brake according to claim 2, wherein the first support surface includes a length along the first plane which is larger than a length of the second support surface along the second plane such that center of the braking torque is located in the first support surface.

5. The disc brake according to claim 2, wherein the support bracket includes a recessed surface comprising the first support surface and the second support surface.

6. The disc brake according to claim 2, wherein the support bracket includes a protruded surface comprising the first support surface and the second support surface.

7. The disc brake according to claim 1, wherein
the first plane intersects with the second plane at an angle greater than 90°.

8. The disc brake according to claim 2, wherein
the first support surface is provided radially inward of the second support surface with respect to a radial direction of the brake disc.

9. The disc brake according to claim 2, wherein
the first support surface is provided radially outward of the second support surface with respect to a radial direction of the brake disc.

10. The disc brake according to claim 1, wherein
the first angle θ1 satisfies:
$$0 ° < θ1 < 45 ° .$$

11. The disc brake according to claim 1, wherein the first contact surface is inclined at the first angle θ1 relative to the normal plane.

12. The disc brake according to claim 2, wherein the second contact surface inclined at the second angle θ2 relative to the normal plane.

13. The disc brake according to claim 2, wherein the first support surface and the second support surface are configured to face an end surface of the rotational direction end of the back plate, and
the first contact surface is a primary end surface of the rotational direction end of the back plate and the second contact surface is a secondary end surface of the rotational direction end of the back plate.

14. The disc brake according to claim 2, wherein the first support surface, the first contact surface, the second support surface and the second contact surface are each substantially planar surface.

15. A disc brake comprising:
a brake disc configured to rotate about a rotation axis thereof;
a caliper;
a pair of friction pads disposed on both sides of the brake disc and supported by the caliper movably in a direction of the rotation axis, each of the friction pads comprising a back plate having a rotational direction end which is an end thereof in a rotational direction of the brake disc,
wherein the caliper comprises a support bracket extending in the direction of the rotation axis, the support bracket supports the rotational direction end of the back plate by surface contact when the caliper presses the pair of friction pads against the brake disc to generate a braking torque applied on the pair of friction pads,
the support bracket includes a first support surface configured to surface contact with a first contact surface of the rotational direction end of the back plate, the first support surface extending along a first plane inclined at a first angle θ1 relative to a normal plane perpendicular to a direction in which the braking torque acts on the pads such that a relative speed is generated between sliding direction of the brake disc and sliding direction of the pads
wherein the support bracket includes a second support surface configured to surface contact with a second contact surface of the rotational direction end of the back plate,
the second support surface extends along a second plane inclined at a second angle θ2 relative to the normal plane,
the first plane intersects with the second plane,
wherein the first support surface of the support bracket is inclined away from a center of the caliper in the rotational direction toward radially outer side,
the second support surface is provided radially outward of the first support surface with respect to a radial direction of the brake disc.

16. The disc brake according to claim 15, further comprising:
a spring applying an elastic bias to the back plate such that the second contact surface is pressed against the second support surface,
the spring is disposed radially inward of the back plate.

17. A disc brake comprising:
a brake disc configured to rotate about a rotation axis thereof;
a caliper;
a pair of friction pads disposed on both sides of the brake disc and supported by the caliper movably in a direction of the rotation axis, each of the friction pads comprising a back plate having a rotational direction end which is an end thereof in a rotational direction of the brake disc,
wherein the caliper comprises a support bracket extending in the direction of the rotation axis, the support bracket supports the rotational direction end of the back plate by surface contact when the caliper presses the pair of friction pads against the brake disc to generate a braking torque applied on the pair of friction pads,
the support bracket includes a first support surface configured to surface contact with a first contact surface of the rotational direction end of the back plate, the first support surface extending along a first plane inclined at a first angle θ1 relative to a normal plane perpendicular to a direction in which the braking torque acts on the pads such that a relative speed is generated between sliding direction of the brake disc and sliding direction of the pads
wherein the support bracket includes a second support surface configured to surface contact with a second contact surface of the rotational direction end of the back plate,
the second support surface extends along a second plane inclined at a second angle θ2 relative to the normal plane,
the first plane intersects with the second plane,
wherein the first support surface of the support bracket is inclined away from a center of the caliper in the rotational direction toward radially inner side,
the second support surface is provided radially inward of the first support surface with respect to a radial direction of the brake disc.

18. The disc brake according to claim 17, further comprising:
a spring applying an elastic bias to the back plate such that the second contact surface is pressed against the second support surface,
the spring is disposed radially outward of the back plate.
